(19) United States
(12) Patent Application Publication
(10) Pub. No.: US 2017/0120999 A1
(43) Pub. Date: May 4, 2017

(54) Vessel Which Floats On Water And Which Generates Electricity

(71) Applicant: Ocean Current Energy LLC, London (GB)

(72) Inventors: William Edward Baxley, Hollywood, FL (US); Patrick James Mulvey, San Diego, CA (US)

(21) Appl. No.: 15/331,174

(22) Filed: Oct. 21, 2016

(30) Foreign Application Priority Data
Nov. 4, 2015 (GB) 1519528.2

(51) Int. Cl. B63H 11/10; B63H 11/107; H02K 7/18; H02K 1/22; H02K 1/12

(52) U.S. Cl. CPC B63H 11/102; H02K 1/22; H02K 1/12; H02K 7/1823; B63H 11/107

(57) ABSTRACT

A vessel (2) which floats on water (4) and which generates electricity, which vessel (2) comprises:
(i) a hull (6);
(ii) at least one water inlet (8) at a front part of the vessel (2);
(iii) at least one water outlet (10) at another part of the vessel (2); and
(iv) apparatus (12) for generating electricity comprising at least one stator (16) and at least one rotor (18),
   and the vessel (2) being such that:
(v) water (4) passing from the water inlet (8) to the water outlet (10) causes the rotor to rotate and thereby the apparatus (12) to generate the electricity.

This invention relates to a vessel which floats on water and which generates electricity.

According to one non-limiting embodiment of the present invention there is provided a vessel which floats on water and which generates electricity, which vessel comprises:
(i) a hull;
(ii) at least one water inlet at a front part of the vessel;
(iii) at least one water outlet at another part of the vessel; and
(iv) apparatus for generating electricity comprising at least one stator and at least one rotor,
   and the vessel being such that:
(v) water passing from the water inlet to the water outlet causes the rotor to rotate and thereby the apparatus to generate the electricity.

The vessel can be easily installed in remote locations. The vessel may be towed to a required location and then moored. Alternatively, if desired, the vessel may be provided with its own engine for enabling it to self-power to a required location. The vessel is thus easily moved over water to a desired location, where it can then be moored. The water may be an ocean, a river, a tidal bay, or a lake. The electrical power can be used for various purposes as determined by requirements at the site where the vessel is moored.

Preferably, the other part of the vessel that contains the water outlet is a side part of the vessel. The water is easily discharged from the side part of the vessel.

Also preferably, the water outlet in the side part of the vessel is close to the water inlet, thereby to minimise the water flow path which the water takes from the water inlet to the water outlet, and thereby to cause the water in the water flow path to generate a minimum of back pressure. With long water flow paths, appreciable back pressure may be generated and this may not always be required.

The vessel may include first closure means for closing the water inlet during transportation of the vessel on the water to an operation site. The use of the first closure means may enable the vessel to present a more streamlined profile to the water, and thereby facilitate movement of the vessel through the water, for example when the vessel is being towed, or when the vessel is under its own power.

Also preferably, the vessel includes second closure means for closing the water outlet during transportation of the vessel on the water to the operation site. The provision of the second closure means may again facilitate the vessel providing an optimum streamlined profile to the water during movement of the vessel through the water.

When the vessel includes the first and second closure means, then the vessel may include first sealing means for sealing at the first closure means, and second sealing means for sealing at the second closure means, whereby the apparatus for generating electricity is able to be located in an enclosure that is able to be pumped free of water. The ability to pump the enclosure free of water is advantageous in times when the vessel is on water but needs maintenance or repair.

When the vessel includes the first and second closure means, then the vessel may also include pump means for pumping the water from the enclosure.

The vessel may be one in which there is at least one of the water outlets on each side of the vessel. In general, there may be as many water outlets as required and at whatever positions are required. Similarly, the vessel may have as many as required of the water inlets.

The vessel may include a keel formation at a rear part of the vessel, the keel formation being such as to give rudder-like steering to the vessel. The keel formation may be advantageous in order to orientate the vessel with a water flow in which the vessel is operating. This orientation of the vessel with the water flow will then help to prevent the vessel from swinging from side to side and thereby fishtailing.

The vessel may be a rectilinear vessel having a front, two sides, and a rear. The vessel may be of other shapes if desired.

The vessel may be a barge. The vessel may be other types of vessel including various shapes and sizes of ships, boats and pontoons.

The vessel may include equipment for serving at least one other function in addition to the generation of the electricity by the apparatus for generating electricity. Any suitable and appropriate function or functions may be employed. Thus, for example, the equipment may be at least one of a desalination unit, a water purification unit, a battery recharging unit, an electrical energy storage unit, a water storage unit, or a cargo holding unit. The cargo holding unit may be for holding, for example, cargo containers.

The vessel may be one which has a surface which contains part of the equipment that is required for the apparatus for generating electricity. Thus, for example, the apparatus for generating electricity may have a stator and a rotor located below deck and in the path of the water as it passes from the water inlet to the water outlet, and the apparatus for generating electricity may have ancillary equipment mounted on the surface of a deck.

An embodiment of the invention will now be described solely by way of example and with reference to the accompanying drawings in which:

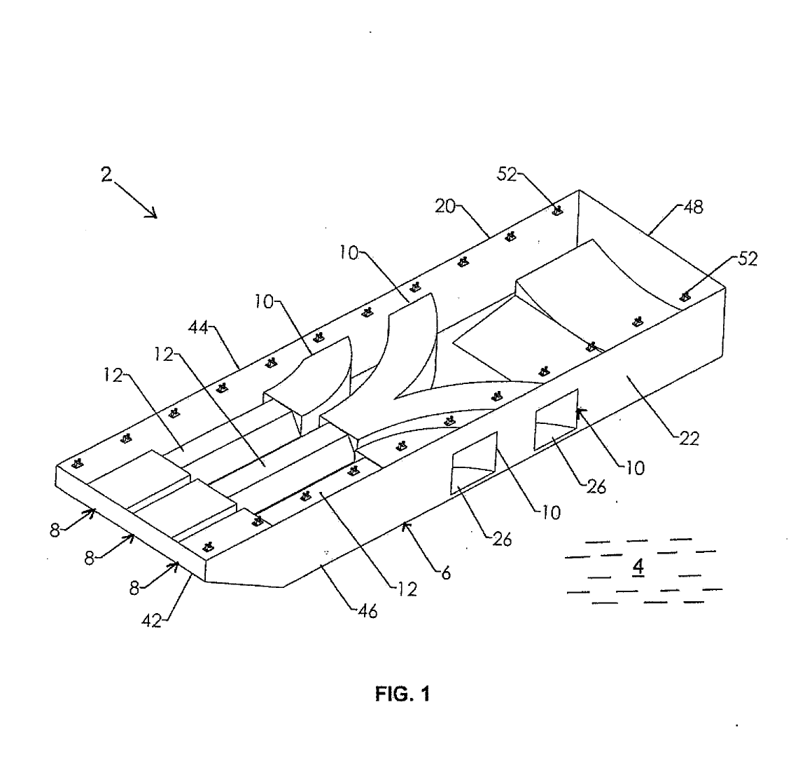

FIG. 1 is a view from the front, above and one side of a vessel which floats on water and which generates electricity, and with the deck of the vessel being removed for purposes of illustration;

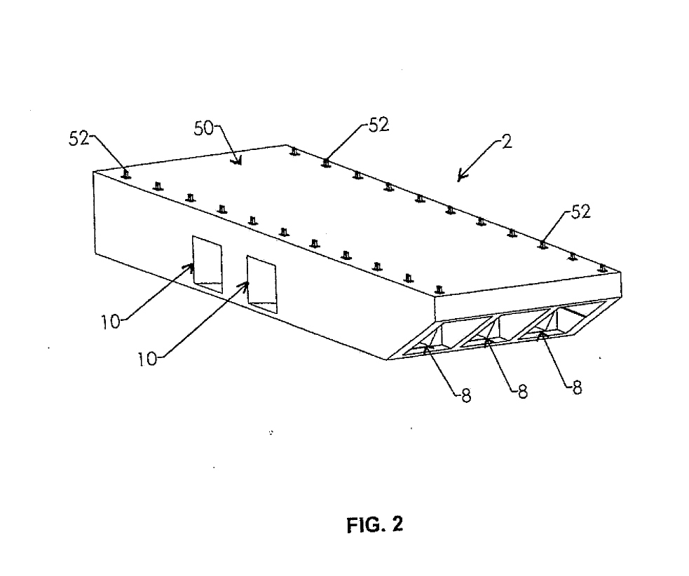

FIG. 2 is a view from the front, above and the other side of the vessel as shown in FIG. 1, and with the deck in place;

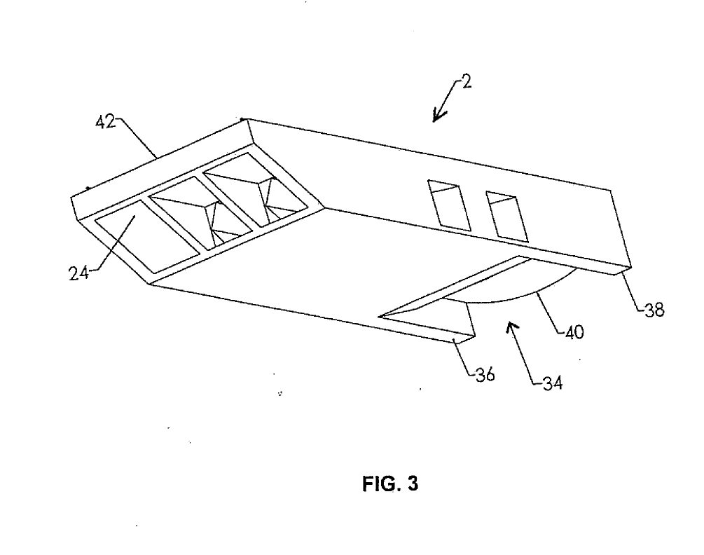

FIG. 3 is a view from the front, one side and underneath of the vessel shown in FIG. 1;

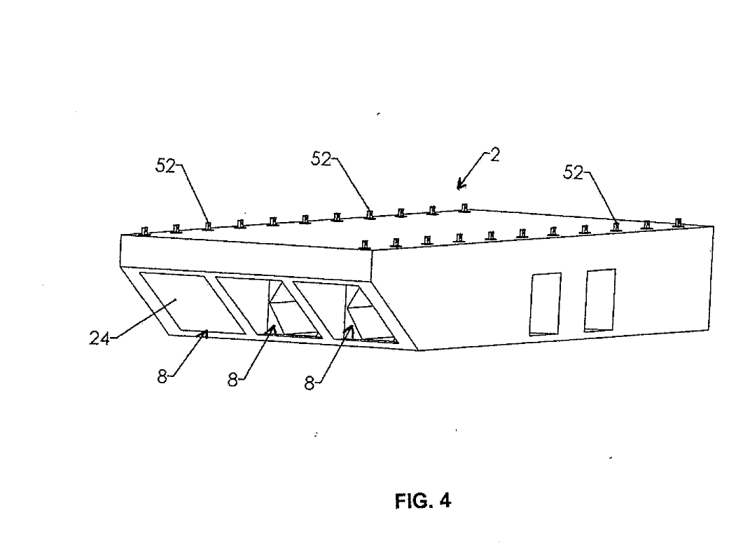

FIG. 4 is a view from the front and one side of the vessel shown in FIG. 1;

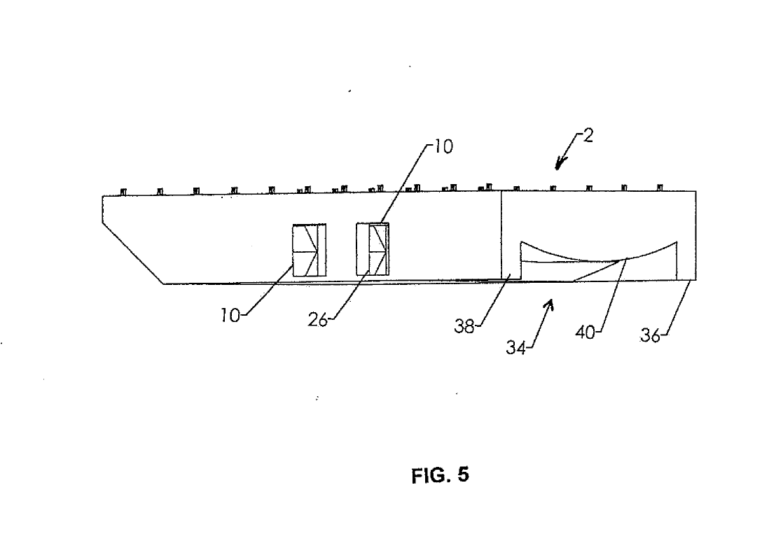

FIG. 5 is a view from the rear and one side of the vessel as shown in FIG. 1; and

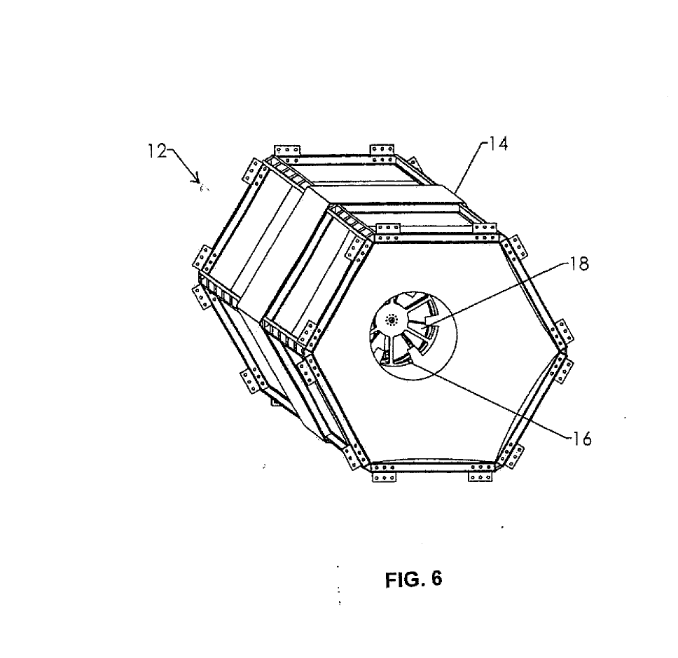

FIG. 6 shows a unit forming part of the apparatus for generating electricity shown in FIG. 1.

Referring to the drawings, there is shown a vessel 2 which floats on water 4 and which generates electricity. The vessel 2 comprises a hull 6, at least one water inlet 8 at a front part of the vessel 2, and at least one water outlet 10 at another part of the vessel 2.

The vessel 2 also comprises apparatus 12 for generating electricity. The apparatus 12 comprises a plurality of housings 14 which are hexagonal in end view as shown. Each housing 14 contains a stator 16 and a rotor 18. The vessel 2 is such that water 4 passing from the water inlet 8 to the water outlet 10 causes the rotor 18 to rotate and thereby the apparatus 12 to generate the electricity.

As can be seen from the drawings, the vessel is such that there are four of the water outlets 10. Two of the water outlets 10 are in a side part 20 of the vessel 2. The other two of the water outlets 10 are in an opposite side part 22 of the vessel 2.

As also shown in the drawings, there are three of the water inlets 8.

The water outlets 10 are advantageously close to the water inlets 8. This minimises the water flow path which the water 4 takes from the water inlets 8 to the water outlets 10. This in turn causes the water 4 in the water flow path to generate a minimum of back pressure.

The vessel 2 includes first closure means 24 for closing the water inlets 8 during transportation of the vessel 2 on the water to an operation site. The first closure means 24 is in the form of a door as shown. When the first closure means 24 is closed, it closes off its respective water inlet 8. This enables the vessel 2 to present a more streamlined profile to the water 4 during travel of the vessel 2 to the operation site.

The vessel 2 includes second closure means 26 for closing the water outlets 10 during transportation of the vessel 2 on the water 4 to the operation site. The second closure means 26 is again a door for each one of the water outlets 10. The second closure means 26 complements the first closure means 24 in enabling the vessel 22 to present a streamlined profile to the water 4 during travel of the vessel 2 over the water 4.

The vessel 2 includes first sealing means 28 for sealing at the first closure means 24. The vessel 2 also includes second sealing means 30 for sealing at the second closure means 26. The first and second sealing means 28, 30 enable the first and second closure means 24, 26 to be shut and thus isolate the interior of the vessel 2 between the first and second closure means 24, 26. This enables the apparatus 12 to be located in an enclosure 32 that is able to be pumped free of water 4. This facility of pumping the enclosure 32 free from the water 4 may be advantageous in times when the apparatus 12 requires maintenance or replacement. This may be especially so if the vessel is located at a remote operation site and/or in conditions when the water 4 is extremely cold. Pump means (not shown) may be employed for pumping the water 4 from the enclosure 32.

As best appreciated from FIGS. 3 and 5, the vessel 2 is such that it includes a keel formation 34. The keel formation 34 comprises a pair of side portions 36, 38, and a central portion 40. The keel formation 34 is at the rear part of the vessel 2 and it is able to give the vessel 2 a rudder-like steering facility. This enables the vessel 2 to orientate itself with the water flow in which the vessel 2 is operating. This in turn helps to prevent the vessel 2 from swerving from side to side and fishtailing in the water flow. This may in turn help to avoid unnecessary strain on moorings.

As can be seen from the drawings, the vessel 2 is a rectilinear vessel having a front 42, sides 44, 46 and a rear 48. The vessel 2 is in the form of a barge.

The vessel 2 has an upper surface in the form of a deck 50. The deck 50 is provided with upstanding tie members 52 as shown. The tie members 52 enable the deck 50 to include equipment for serving at least one other function in addition to the generation of the electricity by the apparatus 12. Thus, for example, the tie members 52 may tie to the deck 50 equipment such for example as one or more of a desalination unit, a water purification unit, a battery recharging unit, an electricity energy storing unit, a water storage unit, or a cargo holding, unit for holding, for example, cargo containers. The tie members 52 may also be used for tying to the deck 50 ancillary parts for the apparatus 12 if it is not desired to mount these ancillary parts below the deck 50.

The vessel 2 is easily constructed and easily installed on site. Once installed in position, the vessel 2 is able to provide for the generation of electricity, which may be especially useful in remote locations and/or disaster areas. The vessel 2 is such that the apparatus 12 generating the electricity is easily serviced, maintained and replaced if necessary.

It is to be appreciated that the embodiment of the invention described above with reference to the accompanying drawings has been given by way of example only and that modifications may be effected. Thus, for example, the vessel 2 may be other than a barge. The apparatus 12 may be another type of electrical generator to that shown. Individual components shown in the drawings are not limited to use in their drawings and they may be used in other drawings and in all aspects of the invention.

1. A vessel which floats on water and which generates electricity, which vessel comprises:
(i) a hull;
(ii) at least one water inlet at a front part of the vessel;
(iii) at least one water outlet at another part of the vessel; and
(iv) apparatus for generating electricity comprising at least one stator and at least one rotor,
and the vessel being such that:
(v) water passing from the water inlet to the water outlet causes the rotor to rotate and thereby the apparatus to generate the electricity.

2. A vessel according to claim 1 in which the other part of the vessel that contains the water outlet is a side part of the vessel.

3. A vessel according to claim 2 in which the water outlet in the side part of the vessel is close to the water inlet, thereby to minimise the water flow path which the water takes from the water inlet to the water outlet, and thereby to cause the water in the water flow path to generate a minimum of back pressure.

4. A vessel according to claim 1 and including first closure means for closing the water inlet during transportation of the vessel on the water to an operation site.

5. A vessel according to claim 4 and including second closure means for closing the water outlet during transportation of the vessel on the water to the operation site.

6. A vessel according to claim 4 and including first sealing means for sealing at the first closure means, and second sealing means for sealing at the second closure means, whereby the apparatus for generating electricity is able to be located in an enclosure that is able to be pumped free of water.

7. A vessel according to claim 6 and including pump means for pumping the water from the enclosure.

8. A vessel according to claim 1 and in which there is at least one of the water outlets on each side of the vessel.

9. A vessel according to claim 1 and including a keel formation at a rear part of the vessel, the keel formation being such as to give rudder-like steering to the vessel.

10. A vessel according to claim 1 in which the vessel is a rectilinear vessel having a front, two sides, and a rear.

11. A vessel according to claim 1 in which the vessel is a barge.

12. A vessel according to claim 1 in which the vessel includes equipment for serving at least one other function in addition to the generation of the apparatus for generating electricity.

13. A vessel according to claim 12 in which the apparatus for serving at least one other function is at least one of a desalination unit, a water purification unit, a battery recharging unit, an electrical energy storage unit, a water storage unit, or a cargo holding unit.

14. A vessel according to claim 1 in which the vessel has a surface which contains part of the equipment that is required for the apparatus for generating the electricity.
